(19) United States
(12) Patent Application Publication
(10) Pub. No.: US 2025/0330650 A1
(43) Pub. Date: Oct. 23, 2025

(54) EXTENSIBLE SUPPLEMENTAL ENHANCEMENT INFORMATION FOR BINARY METADATA FOR VIDEO STREAMS

(71) Applicant: Tencent America LLC, Palo Alto, CA (US)

(72) Inventors: Arianne HINDS, Palo Alto, CA (US); Stephen Wenger, Palo Alto, CA (US)

(73) Assignee: Tencent America LLC, Palo Alto, CA (US)

(21) Appl. No.: 19/182,164

(22) Filed: Apr. 17, 2025

Related U.S. Application Data
(60) Provisional application No. 63/636,491, filed on Apr. 19, 2024.

(51) Int. Cl. H04N 19/70

(52) U.S. Cl. CPC H04N 19/70

(57) ABSTRACT

A method includes receiving a bitstream including visual media data, a supplementary enhancement information (SEI) message, and a first identifier included in a payload of the SEI message; extracting, from the SEI message in accordance with the first identifier, metadata or information referencing the metadata; and decoding the visual media data in accordance with the metadata, in which the metadata comprises binary data, in which referencing the metadata by the SEI message is performed through use of a Uniform Resource Identifier (URI) in the payload of the SEI message, in which interpretation of the first identifier is defined externally to the payload of the SEI message.

### CROSS-REFERENCE TO RELATED APPLICATIONS

This application claims priority from U.S. Provisional Application No. 63/636,491 filed on Apr. 19, 2024, the disclosure of which is incorporated herein by reference in its entirety.

### BACKGROUND

### 1. Field

The disclosed subject matter relates to video coding and decoding, and more specifically, to the carriage and or reference of popular image metadata formats within the coded video stream for video-based applications.

### 2. Description of Related Art

Video coding and decoding using inter-picture prediction with motion compensation has been known for decades. Uncompressed digital video can consist of a series of pictures, each picture having a spatial dimension of, for example, 1920×1080 luminance samples and associated chrominance samples. The series of pictures can have a fixed or variable picture rate (informally also known as frame rate), of, for example 60 pictures per second or 60 Hz. Uncompressed video has significant bitrate requirements. For example, 1080p60 4:2:0 video at 8 bit per sample (1920×1080 luminance sample resolution at 60 Hz frame rate) requires close to 1.5 Gbit/s bandwidth. An hour of such video requires more than 600 GByte of storage space.

One purpose of video coding and decoding can be the reduction of redundancy in the input video signal, through compression. Compression can help reducing aforementioned bandwidth or storage space requirements, in some cases by two orders of magnitude or more. Both lossless and lossy compression, as well as a combination thereof can be employed. Lossless compression refers to techniques where an exact copy of the original signal can be reconstructed from the compressed original signal. When using lossy compression, the reconstructed signal may not be identical to the original signal, but the distortion between original and reconstructed signal is small enough to make the reconstructed signal useful for the intended application. In the case of video, lossy compression is widely employed. The amount of distortion tolerated depends on the application; for example, users of certain consumer streaming applications may tolerate higher distortion than users of television contribution applications. The compression ratio achievable can reflect that: higher allowable/tolerable distortion can yield higher compression ratios.

A video encoder and decoder can utilize techniques from several broad categories, including, for example, motion compensation, transform, quantization, entropy coding, and carriage of supplemental information (e.g., metadata that describes the imagery in the coded bitstream), some of which will be introduced below.

Another technique used in video coding standards is the Supplemental Enhancement Information (SEI) message which enables the carriage of information, within the coded bitstream, that is supplemental to the coded video. Such SEI information may or may not be directly related to the video coding process, i.e., as specified by the video standard, e.g., H.264|AVC, H.265|HEVC, and H.266|VVC. In most cases, the information in SEI messages is relevant to application processes that are executed in tandem with, or closely following, the video decoding process. Such applications can include a rendering process that uses certain SEI messages to adjust the brightness or color space of the decoded video frames prior to presentation by a display device. Another such application process arranges portions of the decoded video into a particular pattern as defined by an SEI message for 360-degree video, e.g., displayed on a head mounted. In general, a large number of applications can be supported through information provided in SEI messages.

Within the current standards that utilize SEI messages, e.g., H.264|AVC, H.265|HEVC, and H.266|VVC, the size of the information that can be carried in the payload of the SEI message is restricted to no more than 255 bytes. For H.266|VVC, SEI messages that are strictly for use by applications are specified in a separate specification entitled “Versatile supplemental enhancement information messages for coded video bitstreams” (VSEI), whereas SEI messages that can affect the decoding process are specified in the main coding specification “Versatile Video Coding.”

One recent area of standardization within the ITU-T/ISO/IEC Joint Video Experts Team (JVET) anticipates the use of coded video bitstreams in applications that leverage artificial intelligence and machine learning techniques. For this standardization effort, a collection of SEI messages is specified, i.e., in the 3.0 edition of the VSEI specification, for use in such applications. Presently, these SEI messages enable the carriage (or reference via Uniform Resource Identifiers) of neural networks that are to be applied to one or more of the decoded pictures from within the video stream. However, not all applications may choose to leverage these newly specified SEI messages as these messages are specified to either reference or carry a neural network model. Rather, there are some AI applications where the neural network does not need to be carried (or referenced from) the coded video stream.

### SUMMARY

According to an aspect of the disclosure, a method performed by at least one processor in a decoder includes receiving a bitstream comprising visual media data, a supplementary enhancement information (SEI) message, and a first identifier included in a payload of the SEI message; extracting, from the SEI message in accordance with the first identifier, metadata or information referencing the metadata; and decoding the visual media data in accordance with the metadata, in which the metadata comprises binary data, in which referencing the metadata by the SEI message is performed through use of a Uniform Resource Identifier (URI) in the payload of the SEI message, in which interpretation of the first identifier is defined externally to the payload of the SEI message.

According to an aspect of the disclosure, a method performed by at least one processor in an encoder includes receiving visual media data; generating a supplemental enhancement information (SEI) message in which a payload of the SEI message includes a first identifier and metadata or a reference to the metadata, encoding the visual media data in accordance with the metadata, generating a bitstream comprising the visual media data and the SEI message, in which the metadata comprises binary data, in which the first identifier indicates whether the payload of the SEI message includes the metadata or a reference to the metadata, in which referencing the metadata by the SEI message is performed through use of a Uniform Resource Identifier (URI) in the payload of the SEI message, and in which interpretation of the first identifier is defined externally to the payload of the SEI message.

According to an aspect of the disclosure, a method of processing visual media data includes: processing a bitstream of visual media data according to a format rule, in which the bitstream includes a supplemental enhancement information (SEI) message in which a payload of the SEI message includes a first identifier and metadata or a reference to the metadata, in which the metadata comprises binary data, in which the first identifier indicates whether the payload of the SEI message includes the metadata or a reference to the metadata, in which referencing the metadata by the SEI message is performed through use of a Uniform Resource Identifier (URI) in the payload of the SEI message, and in which interpretation of the first identifier is defined externally to the payload of the SEI message.

### BRIEF DESCRIPTION OF DRAWINGS

Further features, the nature, and various advantages of the disclosed subject matter will be more apparent from the following detailed description and the accompanying drawings in which:

FIG. 1 is a schematic illustration of a simplified block diagram of a communication system in accordance with an embodiment.

FIG. 2 is a schematic illustration of a simplified block diagram of a communication system in accordance with an embodiment.

FIG. 3 is a schematic illustration of a simplified block diagram of a decoder in accordance with an embodiment.

FIG. 4 is a schematic illustration of a simplified block diagram of an encoder in accordance with an embodiment.

FIG. 5 is a schematic illustration of NAL unit and SEI headers in accordance with an embodiment.

FIG. 6 is a schematic illustration of a simplified encoding and decoding system that employs a simplified neural network post filtering process in which neural network models are carried or referenced from SEI messages.

FIG. 7 is a schematic illustration of a generative AI post filtering process without the carriage or reference of neural network models in SEI messages.

FIG. 8 is a schematic illustration of a capture system that embeds image metadata within a JPEG image.

FIG. 9 is a schematic illustration of the carriage of image metadata within the payload of an SEI message.

FIG. 10 is a schematic illustration of the carriage of JFIF metadata that includes a JFIF extension marker segment within a JPEG image.

FIG. 11 is a schematic illustration of the reference of Exif metadata via a Uniform Resource Identifier (URI) within the payload of an SEI message.

FIG. 12 is a schematic illustration of the ingest of an image metadata SEI message by a simple generative AI post filtering process.

FIG. 13 is an illustration of a syntax of an Exif metadata SEI message according to an embodiment.

FIG. 14 is an illustration of a syntax of a JFIF metadata SEI message according to an embodiment.

FIG. 15 is an illustration of a syntax of an XMP metadata SEI message according to an embodiment.

FIG. 16 is an illustration of a syntax of an ICC profile metadata SEI message according to an embodiment.

FIG. 17 is an illustration of a syntax of a single SEI message that carries binary metadata for EXIF, JFIF, XMP or ICC profile formats.

FIG. 18 is an illustration of a syntax of a single SEI message that carries binary metadata for EXIF. JFIF, XMP, or IFI profile formats

FIG. 19 is a diagram of a computer system suitable for implementing the embodiments of the present disclosure, in accordance with embodiment of the present disclosure.

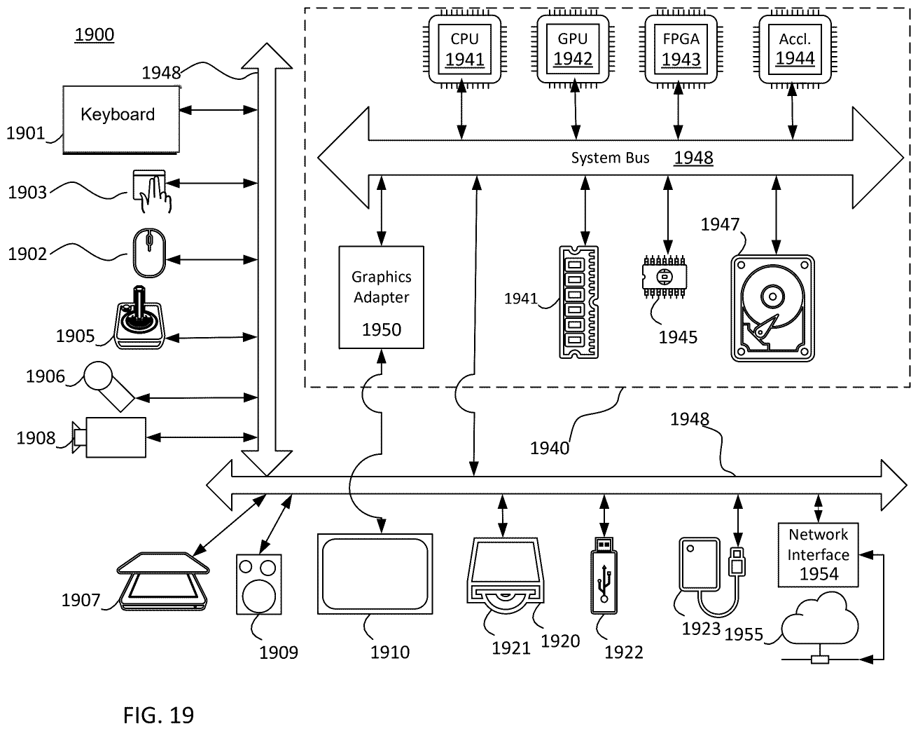

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

According to embodiments of the present disclosure, a single extensible SEI message to enable the carriage of multiple binary metadata formats within coded video streams is disclosed. That is, rather than specify a unique SEI message for each binary metadata format, a single extensible SEI message for binary metadata is herein disclosed in which a “purpose identifier” indicates the type or purpose of the binary metadata in the SEI payload. Examples of binary metadata formats include popular image metadata formats, e.g., Exchangeable Image File (Exif) metadata, JPEG File Interchange Format (JFIF), Extensible Metadata Platform (XMP), and ICC profiles. The metadata may be carried in the payload of the SEI message itself, or as an alternative, the SEI message can be created with a Uniform Resource Identifier (URI) that identifies the exact metadata resource to be obtained from a source external to the video bitstream. A table that is specified in addition to the syntax of the SEI message, in the video coding specification, enables the precise definition for each unique value of the purpose identifier.

In one or more examples, a single SEI message may be a a common SEI message that provides text information for various purposes, and avoids the need to define multiple SEI messages, which provide specific type of text information, while providing future extensibility. The same techniques may be applied to the image metadata formats. Therefore, a single SEI message to carry the binary metadata of image metadata format SEIs is provided to achieve similar benefits of having to avoid the need to define multiple SEI messages that provide specific image metadata information.

The embodiments include at least three separate SEI messages to carry the binary information associated with the metadata for EXIF, JFIF, and XMP. These SEI messages are collectively labelled as “image format metadata SEI messages.” The primary syntax element across the payloads for these SEI messages is a payload byte with the descriptor of b(8), which is read from the video bitstream to collect the binary payloads for each of the SEIs. A single SEI message to carry the binary metadata associated with the image format metadata SEI messages may benefit from the same rationale used to create a single SEI that employs a syntax based on a text string. Such an SEI message would leverage the common syntax of binary payload bytes, with an option to carry the payload via a URI.

In one or more examples, a single SEI message is proposed to carry each of the image format metadata SEI messages. For example, a “type” syntax element may be defined to signal which of the metadata formats is being carried in the SEI message payload. Furthermore, the option to reference the image metadata at a location determined by a URI may be preserved for such a single SEI so that the image metadata payload may be accessed from the location provided by the URI.

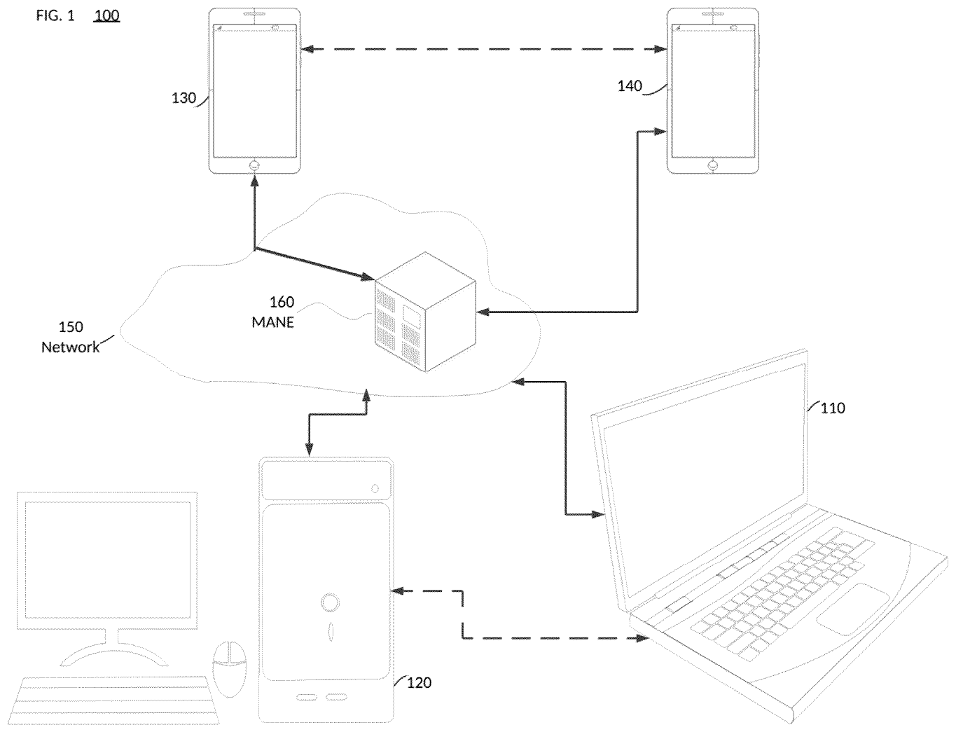

FIG. 1 illustrates a simplified block diagram of a communication system (100) according to an embodiment of the present disclosure. The system (100) may include at least two terminals (110-120) interconnected via a network (150). For unidirectional transmission of data, a first terminal (110) may code video data at a local location for transmission to the other terminal (120) via the network (150). The second terminal (120) may receive the coded video data of the other terminal from the network (150), decode the coded data and display the recovered video data. Unidirectional data transmission may be common in media serving applications and the like.

FIG. 1 illustrates a second pair of terminals (130, 140) provided to support bidirectional transmission of coded video that may occur, for example, during videoconferencing. For bidirectional transmission of data, each terminal (130, 140) may code video data captured at a local location for transmission to the other terminal via the network (150). Each terminal (130, 140) also may receive the coded video data transmitted by the other terminal, may decode the coded data and may display the recovered video data at a local display device.

In FIG. 1, the terminals (110-140) may be illustrated as servers, personal computers and smart phones but the principles of the present disclosure may be not so limited. Embodiments of the present disclosure find application with laptop computers, tablet computers, media players and/or dedicated video conferencing equipment. The network (150) represents any number of networks that convey coded video data among the terminals (110-140), including for example wireline and/or wireless communication networks. The communication network (150) may exchange data in circuit-switched and/or packet-switched channels. Representative networks include telecommunications networks, local area networks, wide area networks and/or the Internet. For the purposes of the present discussion, the architecture and topology of the network (150) may be immaterial to the operation of the present disclosure unless explained herein below. The network (150) may include Media Aware Network Elements (MANEs, 160) that may be included in the transmission path between, for example, terminal (130) and (140). The purpose of a MANE may be selective forwarding of parts of the media data to react to network congestions, media switching, media mixing, archival, and similar tasks commonly performed by a service provider rather than an end user. Such MANEs may be able to parse and react on a limited part of the media conveyed over the network, for example syntax elements related to the network abstraction layer of video coding technologies or standards.

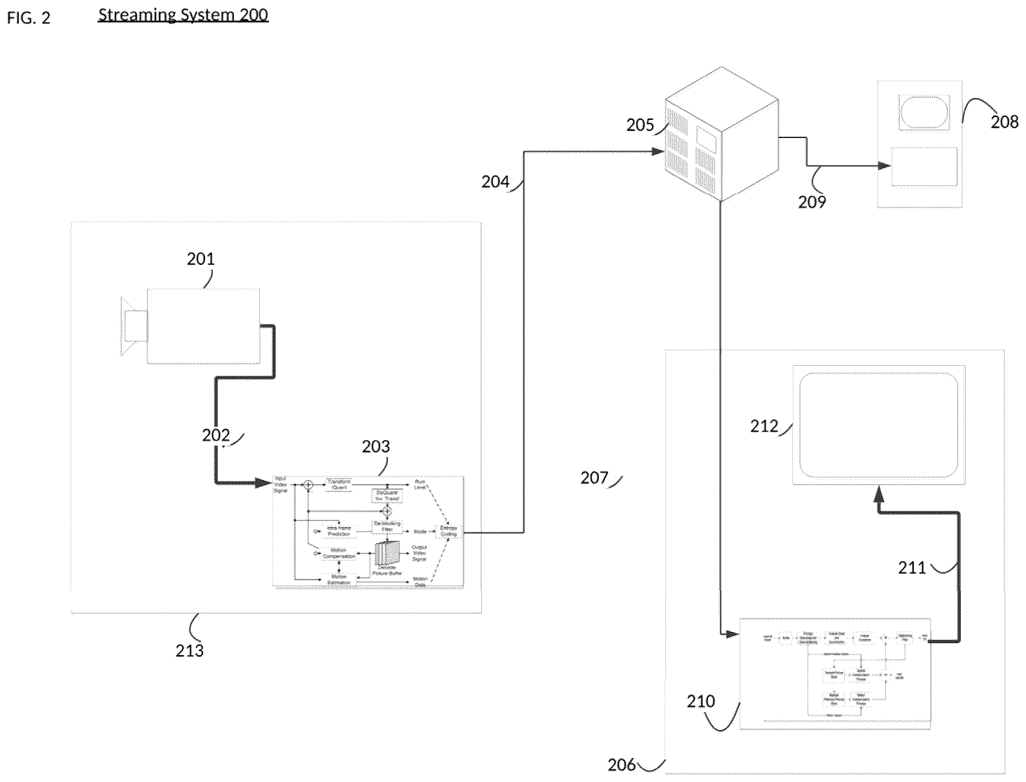

FIG. 2 illustrates, as an example for an application for the disclosed subject matter, the placement of a video encoder and decoder in a streaming environment. The disclosed subject matter can be equally applicable to other video enabled applications, including, for example, video conferencing, digital TV, storing of compressed video on digital media including CD, DVD, memory stick and the like, and so on.

A streaming system may include a capture subsystem (213), that can include a video source (201), for example a digital camera, creating a for example uncompressed video sample stream (202). That sample stream (202), depicted as a bold line to emphasize a high data volume when compared to encoded video bitstreams, can be processed by an encoder (203) coupled to the camera (201). The encoder (203) can include hardware, software, or a combination thereof to enable or implement aspects of the disclosed subject matter as described in more detail below. The encoded video bitstream (204), depicted as a thin line to emphasize the lower data volume when compared to the sample stream (202), can be stored on a streaming server (205) for future use. One or more streaming clients (206, 208) can access the streaming server (205) to retrieve copies (207, 209) of the encoded video bitstream (204). A client (206) can include a video decoder (210) which decodes the incoming copy of the encoded video bitstream (207) and creates an outgoing video sample stream (211) that can be rendered on a display (212) or other rendering device (not depicted). In some streaming systems, the video bitstreams (204, 207, 209) can be encoded according to certain video coding/compression standards. Examples of those standards include ITU-T Recommendations H.265 and H.266. The disclosed subject matter may be used in the context of VVC.

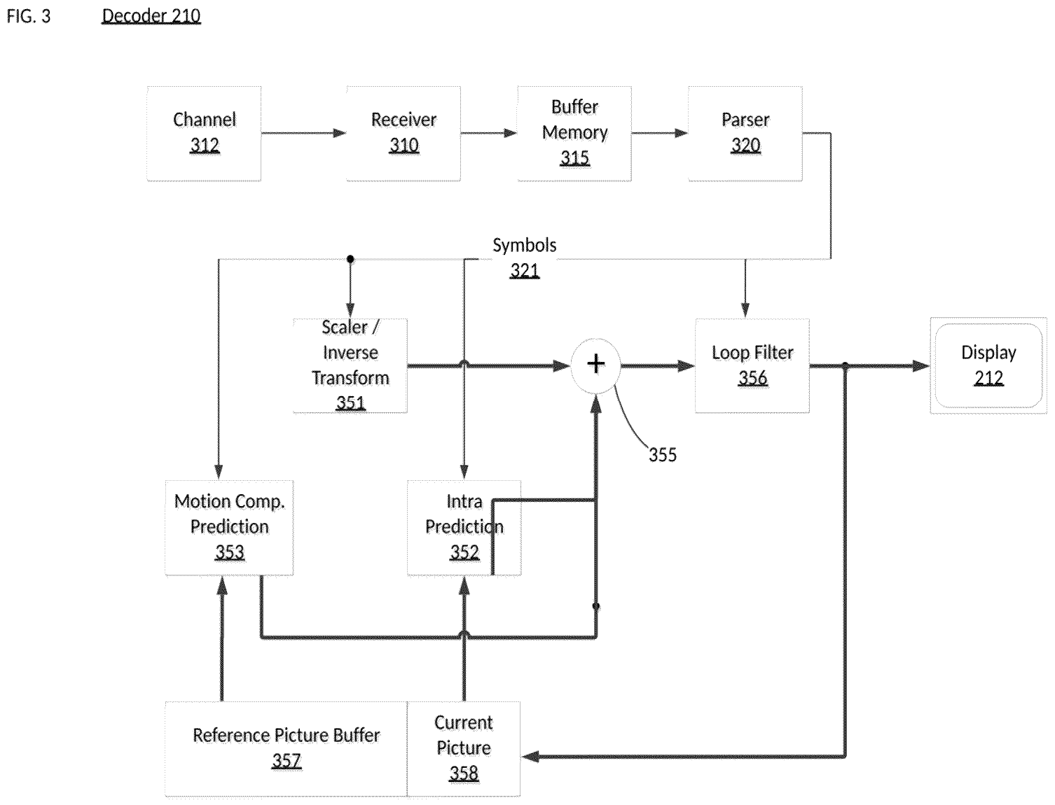

FIG. 3 may be a functional block diagram of a video decoder (210) according to an embodiment of the present invention.

A receiver (310) may receive one or more codec video sequences to be decoded by the decoder (210); in the same or another embodiment, one coded video sequence at a time, where the decoding of each coded video sequence is independent from other coded video sequences. The coded video sequence may be received from a channel (312), which may be a hardware/software link to a storage device which stores the encoded video data. The receiver (310) may receive the encoded video data with other data, for example, coded audio data and/or ancillary data streams, that may be forwarded to their respective using entities (not depicted). The receiver (310) may separate the coded video sequence from the other data. To combat network jitter, a buffer memory (315) may be coupled in between receiver (310) and entropy decoder/parser (320) (“parser” henceforth). When receiver (310) is receiving data from a store/forward device of sufficient bandwidth and controllability, or from an isosychronous network, the buffer (315) may not be needed, or can be small. For use on best effort packet networks such as the Internet, the buffer (315) may be required, can be comparatively large and can advantageously of adaptive size.

The video decoder (210) may include an parser (320) to reconstruct symbols (321) from the entropy coded video sequence. Categories of those symbols include information used to manage operation of the decoder (210), and potentially information to control a rendering device such as a display (212) that is not an integral part of the decoder but can be coupled to it, as was shown in FIG. 2. The control information for the rendering device(s) may be in the form of Supplementary Enhancement Information (SEI messages) or Video Usability Information (VUI) parameter set fragments (not depicted). The parser (320) may parse/entropy-decode the coded video sequence received. The coding of the coded video sequence can be in accordance with a video coding technology or standard, and can follow principles well known to a person skilled in the art, including variable length coding, Huffman coding, arithmetic coding with or without context sensitivity, and so forth. The parser (320) may extract from the coded video sequence, a set of subgroup parameters for at least one of the subgroups of pixels in the video decoder, based upon at least one parameters corresponding to the group. Subgroups can include Groups of Pictures (GOPs), pictures, tiles, slices, macroblocks, Coding Units (CUs), blocks, Transform Units (TUs), Prediction Units (PUs) and so forth. The entropy decoder/parser may also extract from the coded video sequence information such as transform coefficients, quantizer parameter values, motion vectors, and so forth.

The parser (320) may perform entropy decoding/parsing operation on the video sequence received from the buffer (315), so to create symbols (321).

Reconstruction of the symbols (321) can involve multiple different units depending on the type of the coded video picture or parts thereof (such as: inter and intra picture, inter and intra block), and other factors. Which units are involved, and how, can be controlled by the subgroup control information that was parsed from the coded video sequence by the parser (320). The flow of such subgroup control information between the parser (320) and the multiple units below is not depicted for clarity.

Beyond the functional blocks already mentioned, decoder 210 can be conceptually subdivided into a number of functional units as described below. In a practical implementation operating under commercial constraints, many of these units may interact closely with each other and can, at least partly, be integrated into each other. However, for the purpose of describing the disclosed subject matter, the conceptual subdivision into the functional units below is appropriate.

A first unit is the scaler/inverse transform unit (351). The scaler/inverse transform unit (351) receives quantized transform coefficient as well as control information, including which transform to use, block size, quantization factor, quantization scaling matrices, etc. as symbol(s) (321) from the parser (320). It can output blocks comprising sample values, that can be input into aggregator (355).

In some cases, the output samples of the scaler/inverse transform (351) can pertain to an intra coded block; that is: a block that is not using predictive information from previously reconstructed pictures, but can use predictive information from previously reconstructed parts of the current picture. Such predictive information can be provided by an intra picture prediction unit (352). In some cases, the intra picture prediction unit (352) generates a block of the same size and shape of the block under reconstruction, using surrounding already reconstructed information fetched from the current (partly reconstructed) picture (356). The aggregator (355), in some cases, adds, on a per sample basis, the prediction information the intra prediction unit (352) has generated to the output sample information as provided by the scaler/inverse transform unit (351).

In other cases, the output samples of the scaler/inverse transform unit (351) can pertain to an inter coded, and potentially motion compensated block. In such a case, a Motion Compensation Prediction unit (353) can access reference picture memory (357) to fetch samples used for prediction. After motion compensating the fetched samples in accordance with the symbols (321) pertaining to the block, these samples can be added by the aggregator (355) to the output of the scaler/inverse transform unit (in this case called the residual samples or residual signal) so to generate output sample information. The addresses within the reference picture memory form where the motion compensation unit fetches prediction samples can be controlled by motion vectors, available to the motion compensation unit in the form of symbols (321) that can have, for example X, Y, and reference picture components. Motion compensation also can include interpolation of sample values as fetched from the reference picture memory when sub-sample exact motion vectors are in use, motion vector prediction mechanisms, and so forth.

The output samples of the aggregator (355) can be subject to various loop filtering techniques in the loop filter unit (356). Video compression technologies can include in-loop filter technologies that are controlled by parameters included in the coded video bitstream and made available to the loop filter unit (356) as symbols (321) from the parser (320), but can also be responsive to meta-information obtained during the decoding of previous (in decoding order) parts of the coded picture or coded video sequence, as well as responsive to previously reconstructed and loop-filtered sample values.

The output of the loop filter unit (358) can be a sample stream that can be output to the render device (212) as well as stored in the reference picture memory (358) for use in future inter-picture prediction.

Certain coded pictures, once fully reconstructed, can be used as reference pictures for future prediction. Once a coded picture is fully reconstructed and the coded picture has been identified as a reference picture (by, for example, parser (320)), the current reference picture (358) can become part of the reference picture buffer (357), and a fresh current picture memory can be reallocated before commencing the reconstruction of the following coded picture.

The video decoder 320 may perform decoding operations according to a predetermined video compression technology that may be documented in a standard, such as ITU-T Rec. H.266. The coded video sequence may conform to a syntax specified by the video compression technology or standard being used, in the sense that it adheres to the syntax of the video compression technology or standard, as specified in the video compression technology document or standard and specifically in the profiles document therein. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver (310) may receive additional (redundant) data with the encoded video. The additional data may be included as part of the coded video sequence(s). The additional data may be used by the video decoder (320) to properly decode the data and/or to more accurately reconstruct the original video data. Additional data can be in the form of, for example, temporal, spatial, or SNR enhancement layers, redundant slices, redundant pictures, forward error correction codes, and so on.

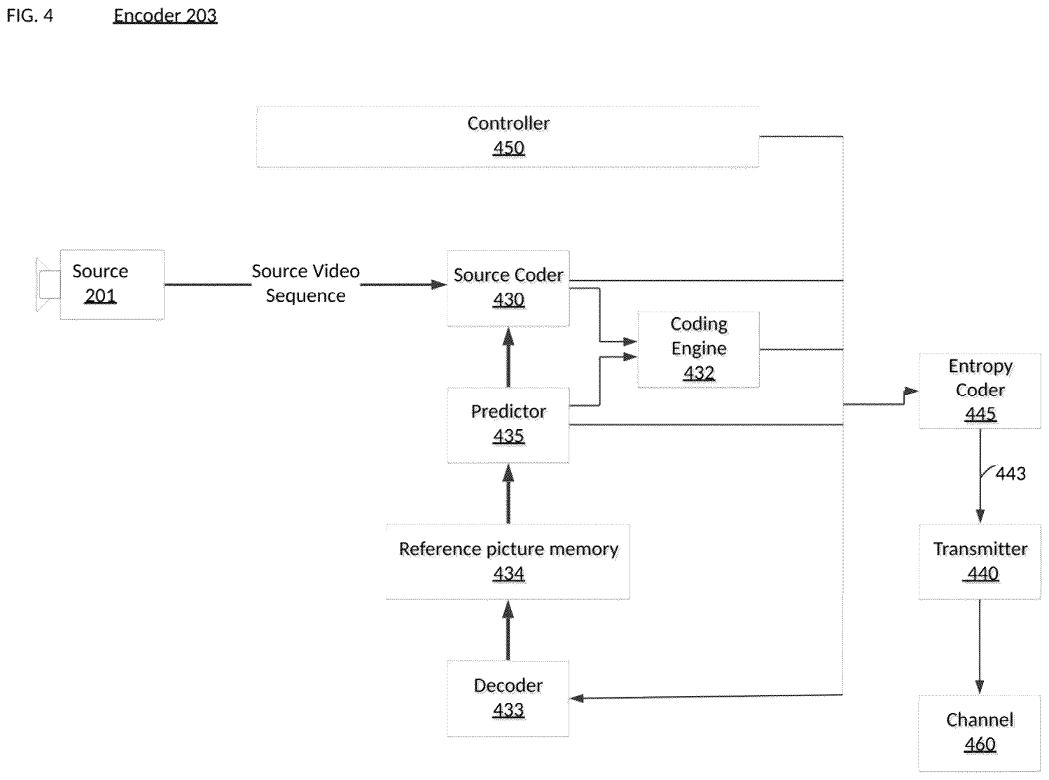

FIG. 4 may be a functional block diagram of a video encoder (203) according to an embodiment of the present disclosure.

The encoder (203) may receive video samples from a video source (201) (that is not part of the encoder) that may capture video image(s) to be coded by the encoder (203).

The video source (201) may provide the source video sequence to be coded by the encoder (203) in the form of a digital video sample stream that can be of any suitable bit depth (for example: 8 bit, 10 bit, 12 bit, . . . ), any colorspace (for example, BT.601 Y CrCB, RGB, . . . ) and any suitable sampling structure (for example Y CrCb 4:2:0, Y CrCb 4:4:4). In a media serving system, the video source (201) may be a storage device storing previously prepared video. In a videoconferencing system, the video source (201) may be a camera that captures local image information as a video sequence. Video data may be provided as a plurality of individual pictures that impart motion when viewed in sequence. The pictures themselves may be organized as a spatial array of pixels, wherein each pixel can comprise one or more sample depending on the sampling structure, color space, etc. in use. A person skilled in the art can readily understand the relationship between pixels and samples. The description below focusses on samples.

According to an embodiment, the encoder (203) may code and compress the pictures of the source video sequence into a coded video sequence (443) in real time or under any other time constraints as required by the application. Enforcing appropriate coding speed is one function of Controller (450). Controller controls other functional units as described below and is functionally coupled to these units. The coupling is not depicted for clarity. Parameters set by controller can include rate control related parameters (picture skip, quantizer, lambda value of rate-distortion optimization techniques, . . . ), picture size, group of pictures (GOP) layout, maximum motion vector search range, and so forth. A person skilled in the art can readily identify other functions of controller (450) as they may pertain to video encoder (203) optimized for a certain system design.

Some video encoders operate in what a person skilled in the are readily recognizes as a “coding loop”. As an oversimplified description, a coding loop can consist of the encoding part of an encoder (430) (“source coder” henceforth) (responsible for creating symbols based on an input picture to be coded, and a reference picture(s)), and a (local) decoder (433) embedded in the encoder (203) that reconstructs the symbols to create the sample data a (remote) decoder also would create (as any compression between symbols and coded video bitstream is lossless in the video compression technologies considered in the disclosed subject matter). That reconstructed sample stream is input to the reference picture memory (434). As the decoding of a symbol stream leads to bit-exact results independent of decoder location (local or remote), the reference picture buffer content is also bit exact between local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is well known to a person skilled in the art.

The operation of the “local” decoder (433) can be the same as of a “remote” decoder (210), which has already been described in detail above in conjunction with FIG. 3. Briefly referring also to FIG. 3, however, as symbols are available and en/decoding of symbols to a coded video sequence by entropy coder (445) and parser (320) can be lossless, the entropy decoding parts of decoder (210), including channel (312), receiver (310), buffer (315), and parser (320) may not be fully implemented in local decoder (433).

An observation that can be made at this point is that any decoder technology except the parsing/entropy decoding that is present in a decoder also necessarily needs to be present, in substantially identical functional form, in a corresponding encoder. For this reason, the disclosed subject matter focusses on decoder operation. The description of encoder technologies can be abbreviated as they are the inverse of the comprehensively described decoder technologies. Only in certain areas a more detail description is required and provided below.

As part of its operation, the source coder (430) may perform motion compensated predictive coding, which codes an input frame predictively with reference to one or more previously-coded frames from the video sequence that were designated as “reference frames.” In this manner, the coding engine (432) codes differences between pixel blocks of an input frame and pixel blocks of reference frame(s) that may be selected as prediction reference(s) to the input frame.

The local video decoder (433) may decode coded video data of frames that may be designated as reference frames, based on symbols created by the source coder (430). Operations of the coding engine (432) may advantageously be lossy processes. When the coded video data may be decoded at a video decoder (not shown in FIG. 4), the reconstructed video sequence typically may be a replica of the source video sequence with some errors. The local video decoder (433) replicates decoding processes that may be performed by the video decoder on reference frames and may cause reconstructed reference frames to be stored in the reference picture cache (434). In this manner, the encoder (203) may store copies of reconstructed reference frames locally that have common content as the reconstructed reference frames that will be obtained by a far-end video decoder (absent transmission errors).

The predictor (435) may perform prediction searches for the coding engine (432). That is, for a new frame to be coded, the predictor (435) may search the reference picture memory (434) for sample data (as candidate reference pixel blocks) or certain metadata such as reference picture motion vectors, block shapes, and so on, that may serve as an appropriate prediction reference for the new pictures. The predictor (435) may operate on a sample block-by-pixel block basis to find appropriate prediction references. In some cases, as determined by search results obtained by the predictor (435), an input picture may have prediction references drawn from multiple reference pictures stored in the reference picture memory (434).

The controller (450) may manage coding operations of the video coder (430), including, for example, setting of parameters and subgroup parameters used for encoding the video data.

Output of all aforementioned functional units may be subjected to entropy coding in the entropy coder (445). The entropy coder translates the symbols as generated by the various functional units into a coded video sequence, by loss-less compressing the symbols according to technologies known to a person skilled in the art as, for example Huffman coding, variable length coding, arithmetic coding, and so forth.

The transmitter (440) may buffer the coded video sequence(s) as created by the entropy coder (445) to prepare it for transmission via a communication channel (460), which may be a hardware/software link to a storage device which would store the encoded video data. The transmitter (440) may merge coded video data from the video coder (430) with other data to be transmitted, for example, coded audio data and/or ancillary data streams (sources not shown).

The controller (450) may manage operation of the encoder (203). During coding, the controller (450) may assign to each coded picture a certain coded picture type, which may affect the coding techniques that may be applied to the respective picture. For example, pictures often may be assigned as one of the following frame types:

An Intra Picture (I picture) may be one that may be coded and decoded without using any other frame in the sequence as a source of prediction. Some video codecs allow for different types of Intra pictures, including, for example Independent Decoder Refresh Pictures. A person skilled in the art is aware of those variants of I pictures and their respective applications and features.

A Predictive picture (P picture) may be one that may be coded and decoded using intra prediction or inter prediction using at most one motion vector and reference index to predict the sample values of each block.

A Bi-directionally Predictive Picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

The video coder (203) may perform coding operations according to a predetermined video coding technology or standard, such as ITU-T Rec. H.266. In its operation, the video coder (203) may perform various compression operations, including predictive coding operations that exploit temporal and spatial redundancies in the input video sequence. The coded video data, therefore, may conform to a syntax specified by the video coding technology or standard being used.

In an embodiment, the transmitter (440) may transmit additional data with the encoded video. The video coder (430) may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and so on.

Compressed video can be augmented, in the video bitstream, by supplementary enhancement information, for example in the form of Supplementary Enhancement Information (SEI) Messages or Video Usability Information (VUI). Video coding standards can include specifications parts for SEI and VUI. SEI and VUI information may also be specified in stand-alone specifications that may be referenced by the video coding specifications.

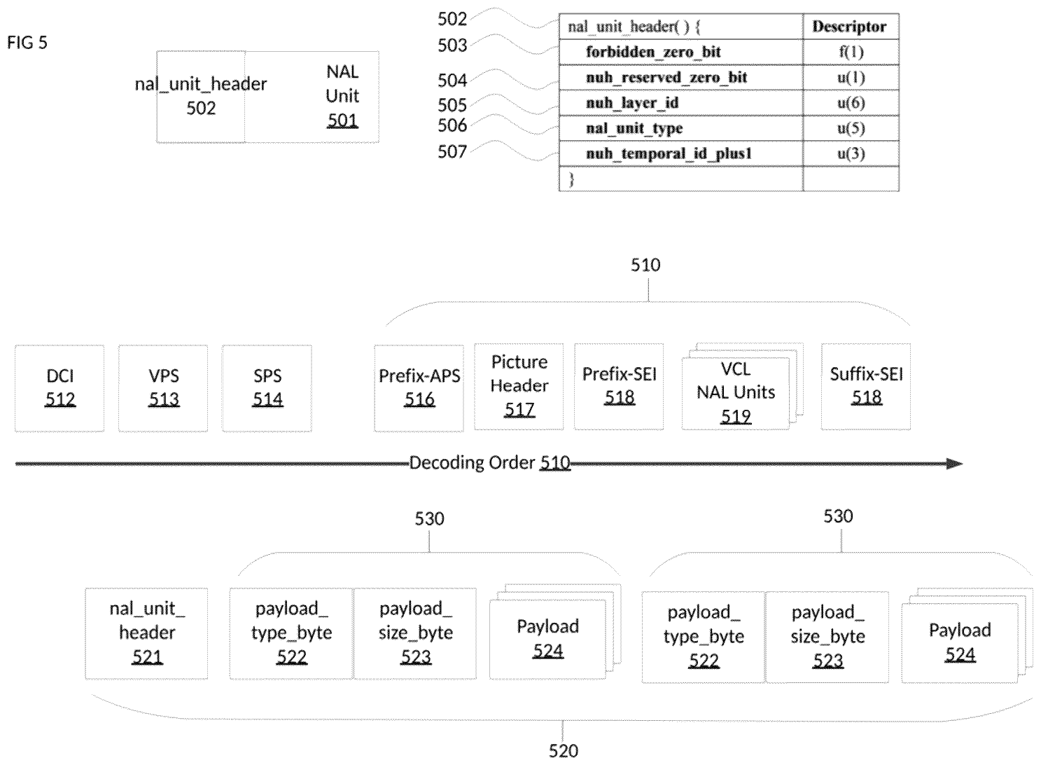

Referring to FIG. 5, shown is an exemplary layout of a Coded Video Sequence (CVS) in accordance with H.266. The coded video sequence is subdivided into Network Abstraction Layer units (NAL units). An exemplary NAL unit (501) can include a NAL unit header (502), which in turn comprises 16 bits as follows: a forbidden_zero_bit (503) and nuh_reserved_zero_bit 504) may be unused by H.266 and may be zero in a NAL unit. compliant with H.266. Three bits of nuh_layer_id (505) may be indicative of the (spatial, SNR, or multiview enhancement) layer to which the NAL unit belongs. Five bits of nuh_nal_unit_type define the type of NAL unit. In H.266 (04/2022), 22 NAL unit type values are defined for NAL unit types defined in H.266, six NAL unit types are reserved, and four NAL unit type values are unspecified and can be used by specifications other than H.266. Finally, three bits of the NAL unit header indicate the temporal layer to which the NAL unit belongs nuh_temporal_id_plus1 (506).

A coded picture may contain one or more Video Coding Layer (VCL) NAL units and zero or more non-VCL NAL units. VCL NAL units may contain coded data conceptually belonging to a video coding layer as introduced before. Non-VCL NAL units may contain data conceptually belonging data not conceptually belonging to the video coding layer. Using H.266 as an example, they can be categorized into:
(1) Parameter sets, which comprise information that can be necessary for the decoding process and can apply to more than one coded picture. Parameter sets and conceptually similar NAL units may be of NAL unit types such as DCI_NUT (Decoding Capability Information (DCI)), VPS_NUT (Video Parameter Set (VPS), establishing, among other things, layer relationships), SPS_NUT (Sequence Parameter Set (SPS), establishing, among other things, parameters used and staying constant throughout a coded video sequence CVS), PPS_NUT (Picture Parameter Set (PPS), establishing, among other things, parameter used and staying constant within a coded picture), and PREFIX_APS_NUT and SUFFIX_APS_NUT (prefix and suffix Adaptation Parameter Sets). Parameter sets may include information required for a decoder to decode VCL NAL units, and hence are referred here as “normative” NAL units.
(2) Picture Header (PH_NUT), which is also a “normative” NAL unit.
(3) NAL units marking certain places in a NAL unit stream. Those include NAL units with the NAL unit types AUD_NUT (Access Unit Delimiter), EOS_NUT (End of Sequence) and EOB_NUT (End of Bitstream). These are non-normative, also known as informative, in the sense that a compliant decoder does not require them for its decoding process, although it needs to be able to receive them in the NAL unit stream.
(4) Prefix and Suffix SEI Nal unit types (PREFIX_SEI_NUT and SUFFIX_SEI_NUT) which indicate NAL units containing Prefix and Suffix supplementary enhancement information. IN H.266 (04/2022), those NAL units are informative, as they are not required for the decoding process.
(5) Filler Data NAL unit type FD_NUT indicates filler data; data that can be random and can be used to “waste” bits in a NAL unit stream or bitstream, which may be necessary for the transport over certain isochronous transport environments.
(6) Reserved and Unspecified NAL unit types.

Still referring to FIG. 5, shown is a layout of a NAL unit stream in decoding order (510) containing a coded picture (511) containing NAL units of some of the types previously introduced. Somewhere early in the NAL unit stream, DCI (512), VPS (513), and SPS (514) may, in combination, establish the parameters which the decoder can use to decode the coded pictures of a coded video sequence (CVS), including coded picture (511) of the NAL unit stream.

The coded picture (511) can contain, in the depicted order or any other order compliant with the video coding technology or standard in use (here: H.266): a Prefix APS (516), Picture header (PH, 517), prefix SEI (518), one or more VCL NAL units (519), and suffix SEI (520).

Prefix and suffix SEI NAL units (518 and 520) were motivated during the standards development as, for some SEI messages, the content of the message would be known before the coding of a given picture commences, whereas other content would only be known once the picture were coded. Allowing certain SEI messages to appear early or late in a coded picture's NAL unit stream through prefix and suffix SEIs allows avoiding buffering. As one example, in an encoder the sampling time of a picture to be coded is known before the picture is coded, and hence the picture timing SEI message can be a prefix SEI message (516). On the other hand, a decoded picture hash SEI message, which contains a hash of the sample values of a decoded pictures and can be useful, for example, to debug encoder implementations, is a suffix SEI message (518) as an encoder cannot calculate a hash over reconstructed samples before a picture has been coded. The location of Prefix and Suffix SEI NAL units may not be restricted to their position in the NAL unit stream. The phrase “Prefix” and “Suffix” may imply to what coded pictures or NAL units the Prefix/Suffix SEI message may pertain to, and the details of this applicability may be specified, for example in the semantics description of a given SEI message.

Still referring to FIG. 5, show is a simplified syntax diagram of a NAL unit that contains a prefix or suffix SEI message 520. This syntax is a container format for multiple SEI messages that can be carried in one NAL unit. Details of the emulation prevention syntax specified in H.266 are omitted here for clarity. As other NAL units, SEI NAL units start with a NAL unit header (521). The header is followed by one or more SEI messages; two are depicted (530, 531) and described henceforth. Each SEI message inside the SEI NAL unit includes an 8 bit payload_type_byte (522) which specifies one of 256 different SEI types; an 8 bit payload_size_byte (523) which specifies the number of bytes of the SEI payload, and payload_size-byte number of bytes Payload (524). This structure can be repeated until a payload_type_byte equal to Oxff is observed, which indicates the end of the NAL unit. The syntax of the Payload (524) depends on the SEI message, it can be of any length between 0 and 255 bytes.

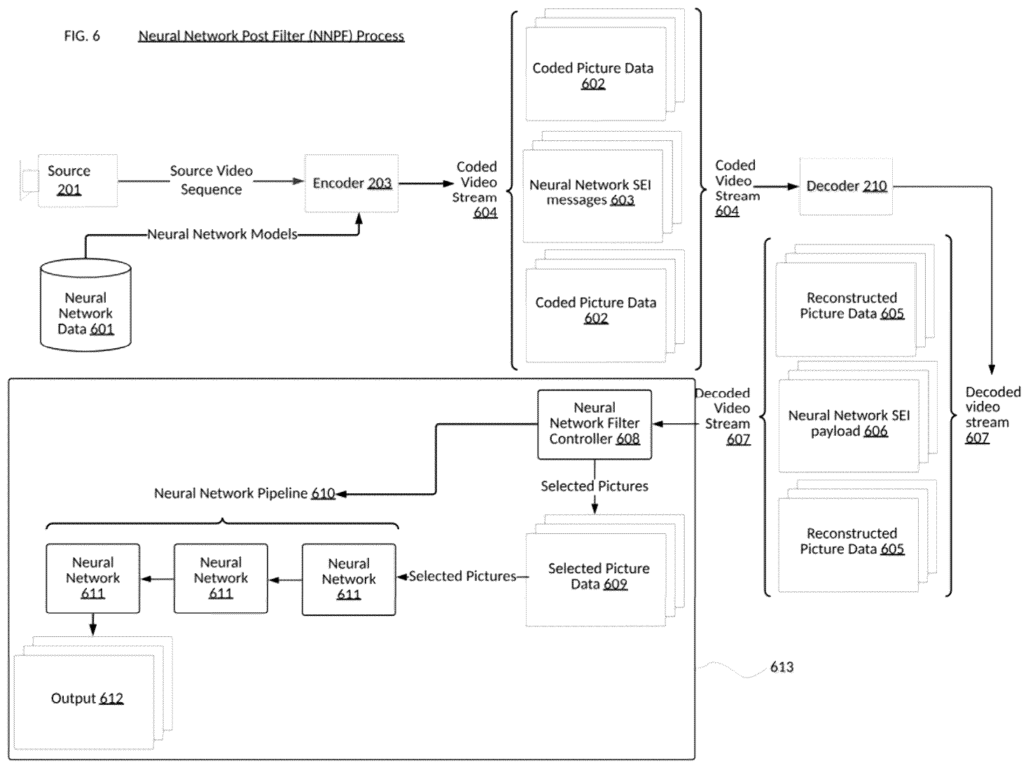

FIG. 6 may be a functional block diagram of a simple encoding and decoding system that employs a neural network post filtering process (613) in which the neural network models are either carried in the payload of the SEI message or referenced (not depicted) in the SEI message by a URI to a source external to the coded video stream. Such an example system can include a video source (201), for example a digital camera, creating a for example source video sequence that is input to an encoder (203). In addition to the source video sequence, the encoder (203) can receive input from a for example separate source (601) that contains one or more neural network models that can be used in a post filtering process (613). The output from the encoder (203) is a coded video stream (604) comprised of one or more sequences of coded picture data (602) and SEI messages (603) that may reference (not depicted) or carry neural network model information in the payload of the SEI messages (603). Coded video stream (604) is input into a decoder (210) that can output the decoded video stream (607) comprised of sequences of reconstructed picture data (605) and payloads (606) of the neural network SEI messages. Decoded video stream (604) can be input to a neural network post filtering process (613) in which a neural network filter controller (608) performs any series of steps that can include: 1) selecting picture data (609) from amongst the data in the decoded video stream (607) and establishing a sequence of one or more neural network filters (611) that comprise a “pipeline” (610) of neural network filters according to the SEI payloads (606). Output (612) from the neural network pipeline (610) may also be the output from the neural network post filtering process (613).

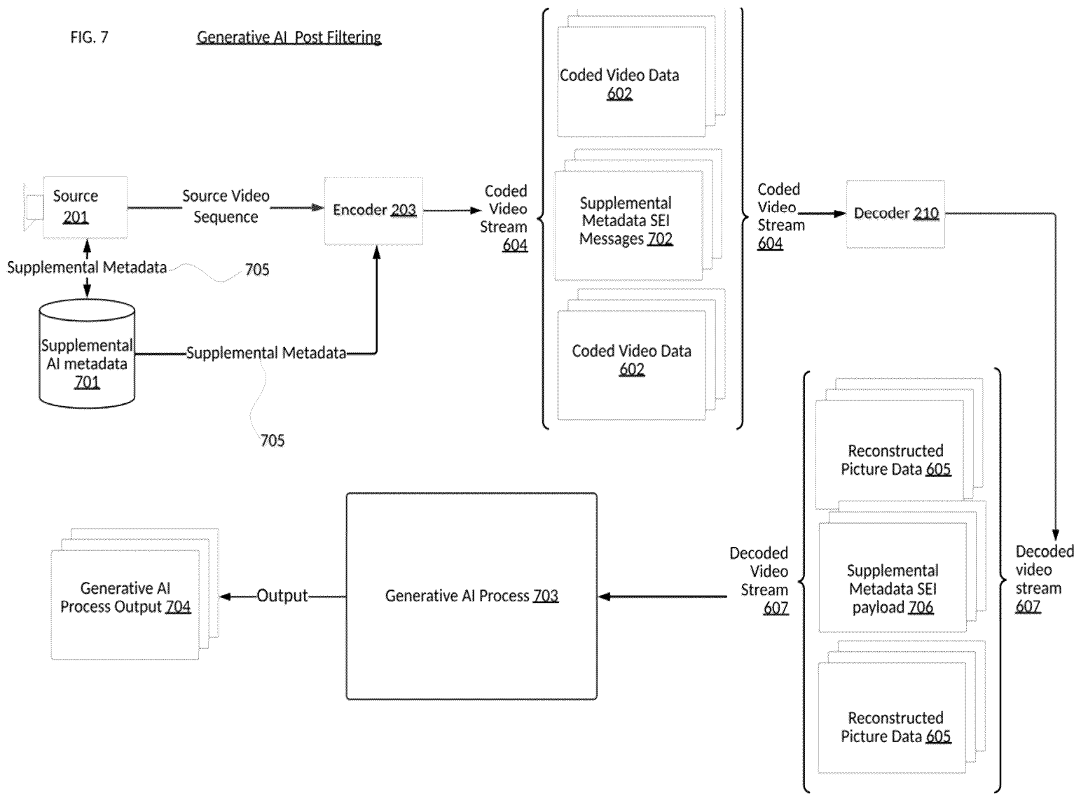

FIG. 7 may be a functional block diagram of a simple encoding and decoding system that employs a generative AI post filtering process (703). Such an example system can include a video source (201), for example a digital camera, creating a for example source video sequence that is input to an encoder (203). Depicted in the figure is a separate source (701) of supplemental metadata (705). However, an alternative source for the supplemental metadata (705) may be from the original video source (201), e.g., a digital camera, itself as most digital cameras already create supplemental metadata in tandem with capturing the source images. Note that the figure does not depict the supplemental metadata (705) being emitted directly from the video source (201) to the encoder (203). Nevertheless, FIG. 7 depicts that the encoder (203) can receive both the supplemental metadata and the source video sequence. The supplemental metadata can be obtained by the encoder (203) from the separate source (701) or it can be obtained directly as the output from the video source (201) which is not depicted.

The output from the encoder (203) is a coded video stream (604) comprised of one or more sequences of coded picture data (602) and SEI messages (702) that may reference (not depicted) or carry the supplemental metadata in the payload of the SEI messages (702). Coded video stream (604) is input into a decoder (210) that can output the decoded video stream (607) comprised of sequences of reconstructed picture data (605) and payloads (706) of the supplemental metadata SEI messages. Decoded video stream (604) can be input to a generative AI post filtering process (703). Output (704) can be from the generative AI post filtering process (703).

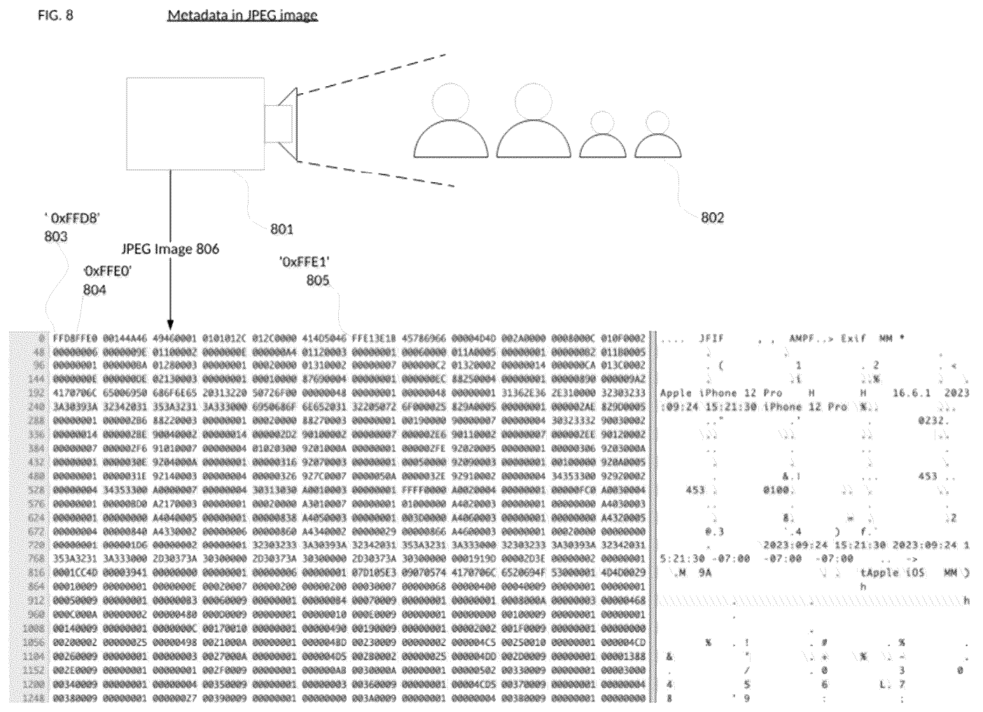

FIG. 8 can be an illustration of a capture system that embeds JFIF and Exif metadata within a JPEG image. In the figure, digital camera (801) captures a scene (802) and can emit JPEG image (806). A portion of JPEG image (805) can be represented by the sequence of hexadecimal numbers (and corresponding ASCII interpretation) shown in the figure in which ‘0xFFD8’ represents the “Start of Image” JPEG marker (803) as specified in the JPEG image coding standard (formally known as Digital compression and coding of continuous-tone still images—Requirements and guidelines).

In FIG. 8, APP0 marker segment (804) which is defined by the sequence ‘0xFFE0’ in the JPEG standard marks the beginning the JFIF metadata, which is further illustrated below. The JFIF metadata may be specified by an ITU-T Recommendation.

Also in FIG. 8, APP1 marker segment (805) which is defined by the sequence ‘0xFFE1’ in the JPEG standard marks the beginning the Exif metadata. The Exif metadata is specified by any of the existing Exif specifications developed jointly by the Camera and Imaging Products Association (CIPA) and the Japan Electronics and Information Technology Industries Association (JEITA).

FIG. 8 does not provide an exact example of XMP metadata, although the XMP metadata can also be carried by APP1 marker segment when stored in a JPEG image.

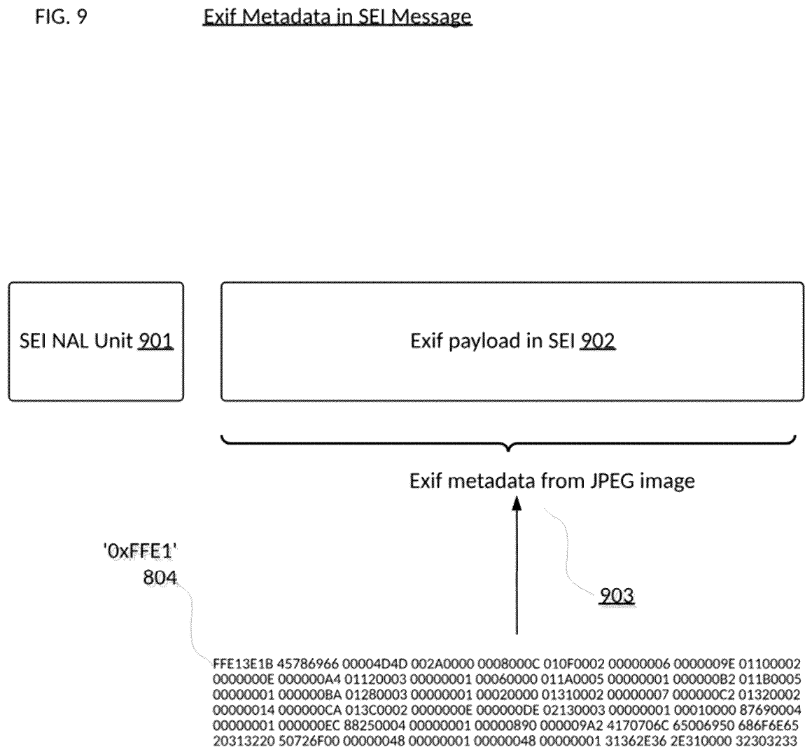

FIG. 9 is an illustration of the carriage of binary image metadata in an SEI message. In this illustration, a portion of Exif metadata (903) beginning with APP1 marker (805) serves as an example of binary metadata that can be packaged into an SEI message (902) that can be specified by a video standard for the purpose of carrying the Exif metadata payload in a coded video stream created by an encoder (not shown). As per the specifications of video standards, the presence of SEI message (902) is signaled by an SEI NAL unit (901).

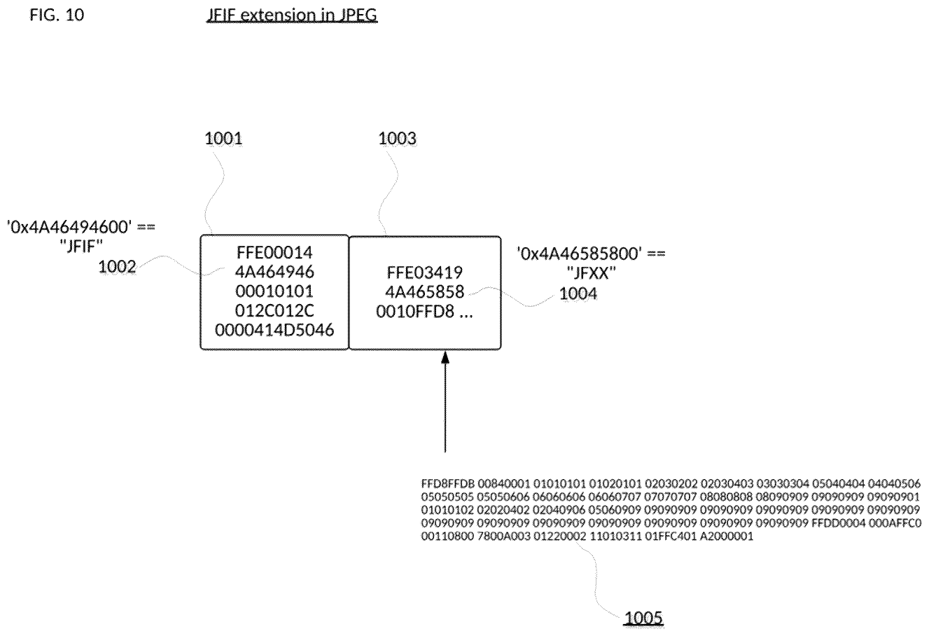

FIG. 10 is another illustration of JFIF metadata in which the metadata includes a JFIF extension according to its ITU-T Recommendation. In this illustration, the beginning portion (1001) of the JFIF metadata can be identified by the hexadecimal values of ‘0x4A46494600’ stored in an APP0 marker segment of ‘0xFFE0’ in which the ASCII representation of ‘0x4A46494600’ (1002) is: “JFIF”. Proceeding the beginning portion (1001) is a JFIF extension (1003) which can be identified by the hexadecimal values of ‘0x4A46585800’ that can be stored in a subsequent APPO marker segment of ‘0xFFE0’. The ASCII representation (904) of ‘0x4A46585800’ is “JFXX”. In this illustration, extension (1003) carries a “thumbnail” representation (1005) of the original image (805). In this illustration the thumbnail is also compressed using the coding scheme specified in ITU-T Recommendation T.81 and hence is signaled by the ‘0xFFD8’ Start of Image marker segment.

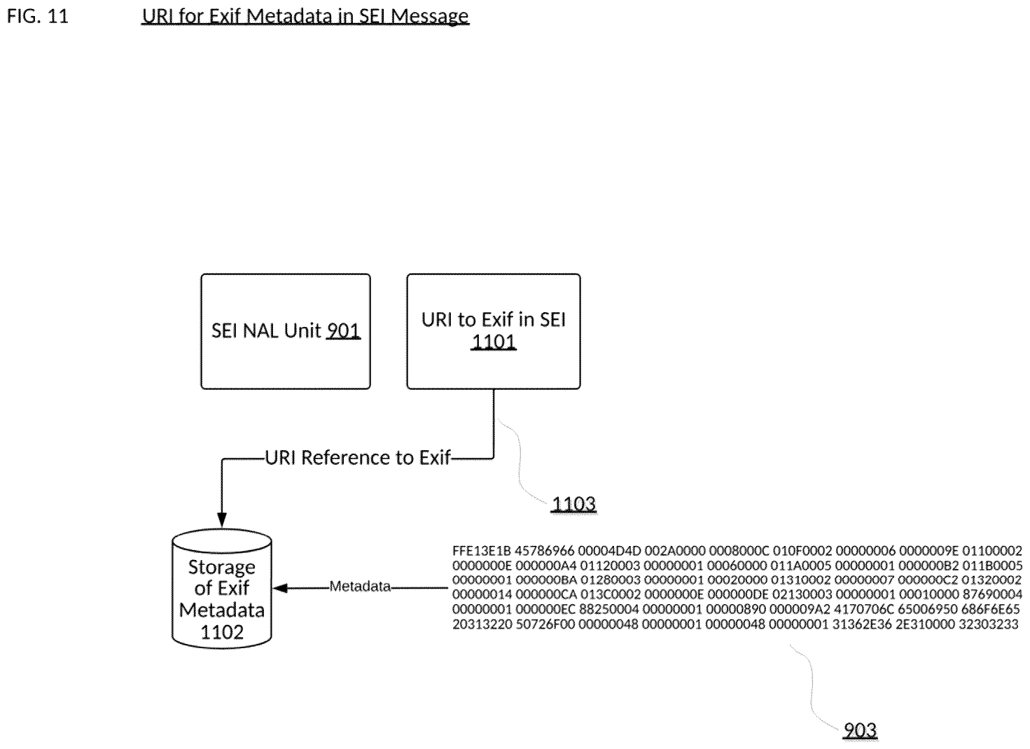

FIG. 11 is an illustration of alternative embodiment of an SEI message (1101) for the carriage of Exif metadata (903) in which the portion of Exif metadata (903) can be referenced by a URI (1103) from within the payload of SEI message (1101). In this illustration of the alternative embodiment, the portion of the Exif metadata resides at or in a location (1102) separate from SEI message (1101).

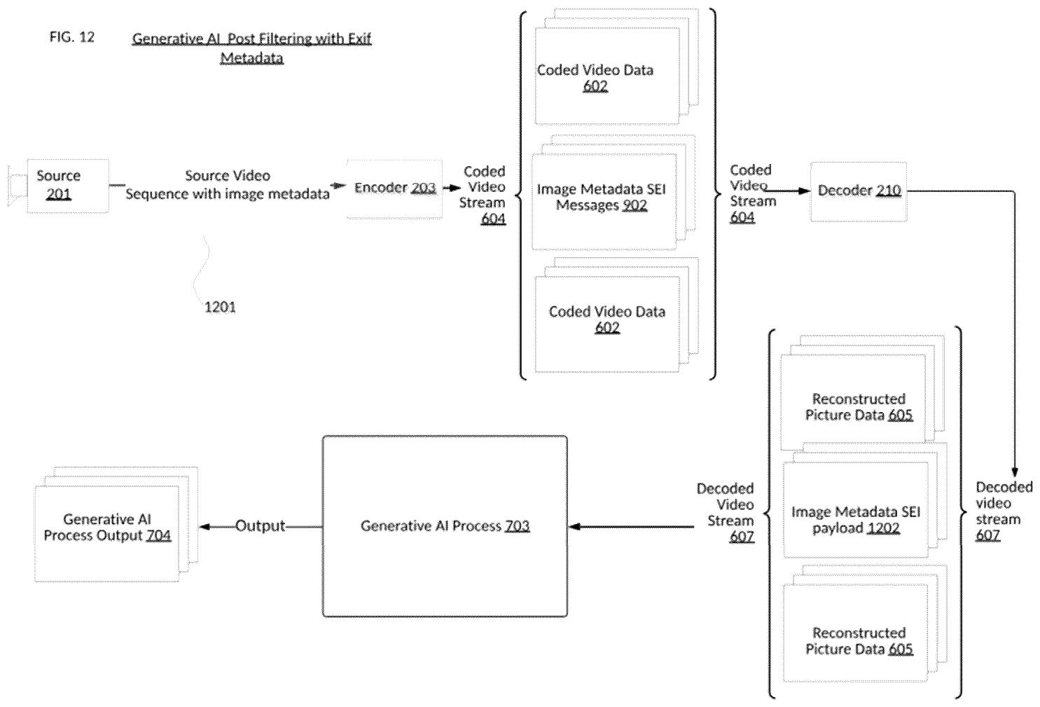

FIG. 12 is an illustration of a system that can use binary image metadata embedded within a video sequence (1201) created by a source (201) in a generative AI post filtering process (703). Sequence (1201) can be input to encoder (203). Output from encoder (203) can be a coded video stream (604) comprised of for example coded video data (602) and binary image metadata SEI messages (902). Coded video stream (604) can be reconstructed by a decoder (210) that can output decoded video stream (607). Stream (607) can be comprised of reconstructed picture data (605) and image metadata payloads (1102). Stream (607) can be input to a generative AI process (703) that can then create generative AI process output (704).

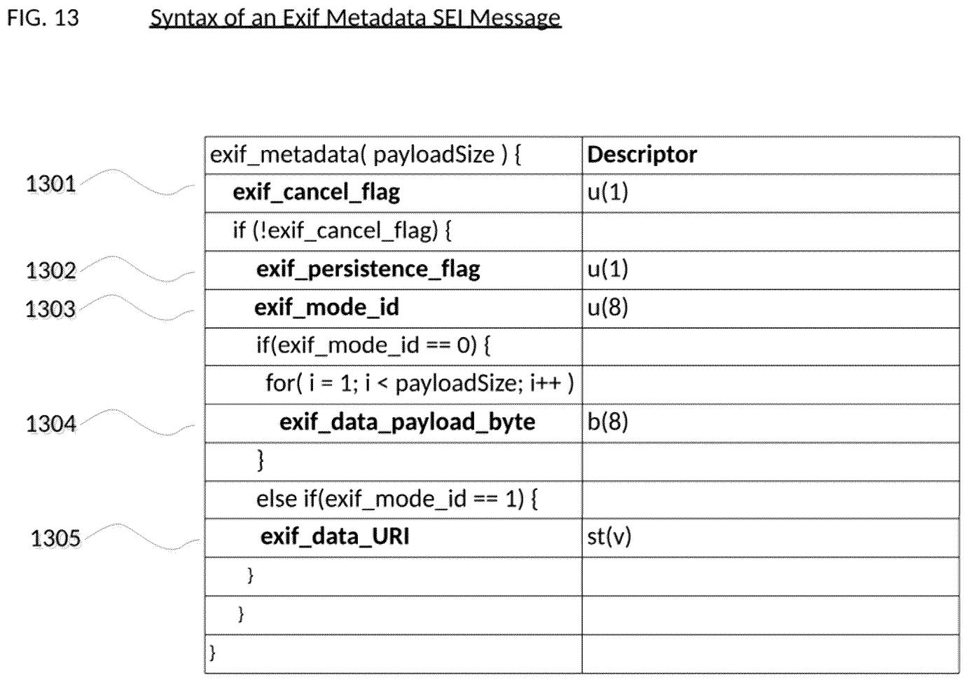

FIG. 13 can be an embodiment of a syntax for an Exif SEI message. Cancel flag (1301) can be used to disable the persistence of a previously processed Exif SEI message. If flag (1301) is set to a value indicating ‘true’ then processing of the current Exif SEI message can complete. If flag (1301) is set to a value indicating ‘false’ then Exif persistence flag (1302) signals the range by which the current Exif SEI message persists. It can be a common practice in the specification of SEI messages that such messages define both a “cancel” and “persistence” flag, as illustrated in flags (1301) and (1302) respectively, in which case the semantics of such flags can be consistently applied throughout the VSEI standard.

Referring still to FIG. 13, Exif mode ID (1303) can indicate whether the payload of the SEI message is the Exif metadata itself or a URI for the location of the Exif metadata. If mode ID (1303) is equal to ZERO, then Exif data payload byte (1304) receives a byte of data from the SEI payload. If mode ID (1303) is equal to ONE, then Exif data URI (1305) receives a string of data from the SEI payload.

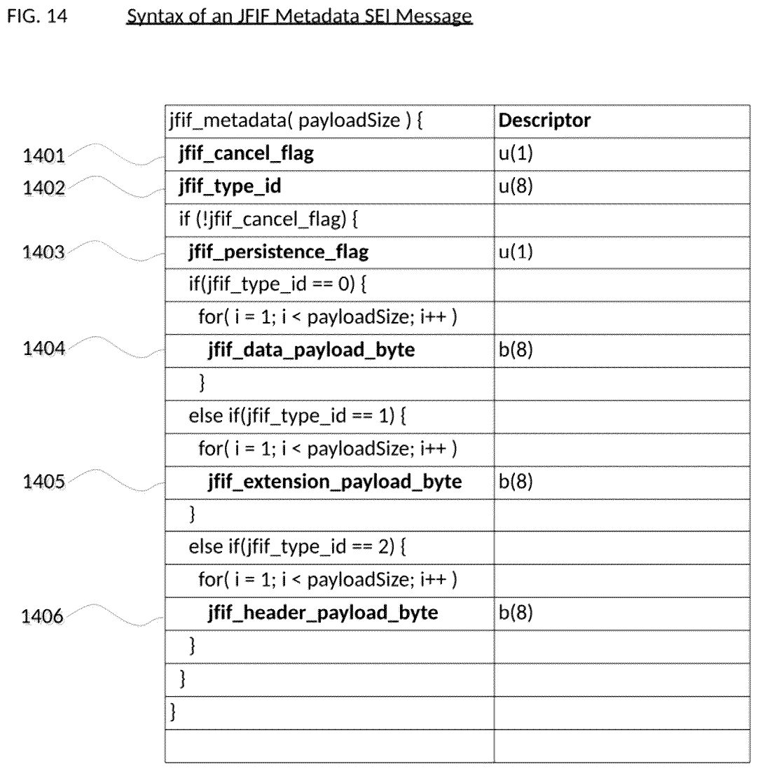

FIG. 14 can be an embodiment of a syntax for a JFIF SEI message. Cancel flag (1401) can be used to disable the persistence of a previously processed JFIF SEI message, and JFIF type ID (1402) can signal the type of JFIF payload that is carried in the remainder of the SEI payload. If flag (1401) is set to a value indicating ‘true’ then processing of the current JFIF SEI message can complete. If flag (1401) is set to a value indicating ‘false’ then JFIF persistence flag (1403) signals the range by which the current JFIF SEI message persists. As above, it can be a common practice in the specification of SEI messages that such messages define both a “cancel” and “persistence” flag, as illustrated in flags (1401) and (1403) respectively, in which case the semantics of such flags may be consistently applied throughout the VSEI standard.

Referring still to FIG. 14, if type ID (1402) is equal to a value of ZERO, then the type of JFIF payload can be comprised of bytes from both types of JFIF marker segments including: 1) a beginning portion (as illustrated in FIG. 10 as 1001) of JFIF data signaled with the string “JFIF” (1002) and 2) a subsequent portion (as illustrated in FIG. 10 as 1003) of JFIF data signaled with the string “JFXX” (1004); in which case a JFIF data payload byte (1404) receives a byte of data from the SEI payload. If type ID (1402) is equal to a value of ONE, then the type of JFIF payload can be comprised of bytes from JFIF marker segments (as illustrated in FIG. 10 as 1003) of JFIF data signaled with the string “JFXX” (1004); in which case a JFIF extension payload byte (1405) receives a byte of data from the SEI payload. If type ID (1402) is equal to a value of TWO, then the type of JFIF payload can be comprised of bytes from JFIF marker segments (as illustrated in FIG. 10 as 1001) of JFIF data signaled with the string “JFIF” (1002); in which case a JFIF header payload byte (1406) receives a byte of data from the SEI payload.

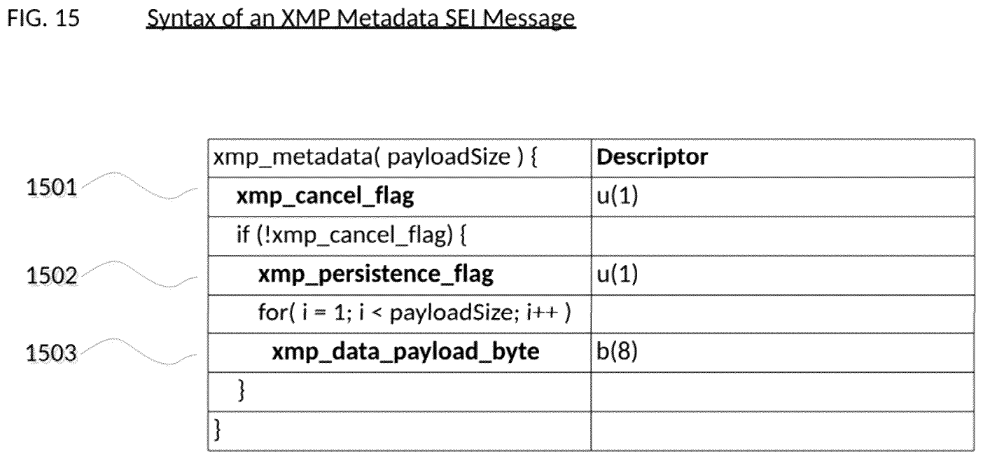

FIG. 15 can be an embodiment of a syntax for an XMP SEI message. Cancel flag (1501) can be used to disable the persistence of a previously processed XMP SEI message. If flag (1501) is set to a value indicating ‘true’ then processing of the current XMP SEI message can complete. If flag (1501) is set to a value indicating ‘false’ then XMP persistence flag (1502) signals the range by which the current XMP SEI message persists. It can be a common practice in the specification of SEI messages that such messages define both a “cancel” and “persistence” flag, as illustrated in flags (1501) and (1502) respectively, in which case the semantics of such flags can be consistently applied throughout the VSEI standard.

Referring still to FIG. 15, if flag (1501) is set to a value indicating ‘false’ then XMP data payload byte (1503) receives a byte of data from the SEI payload.

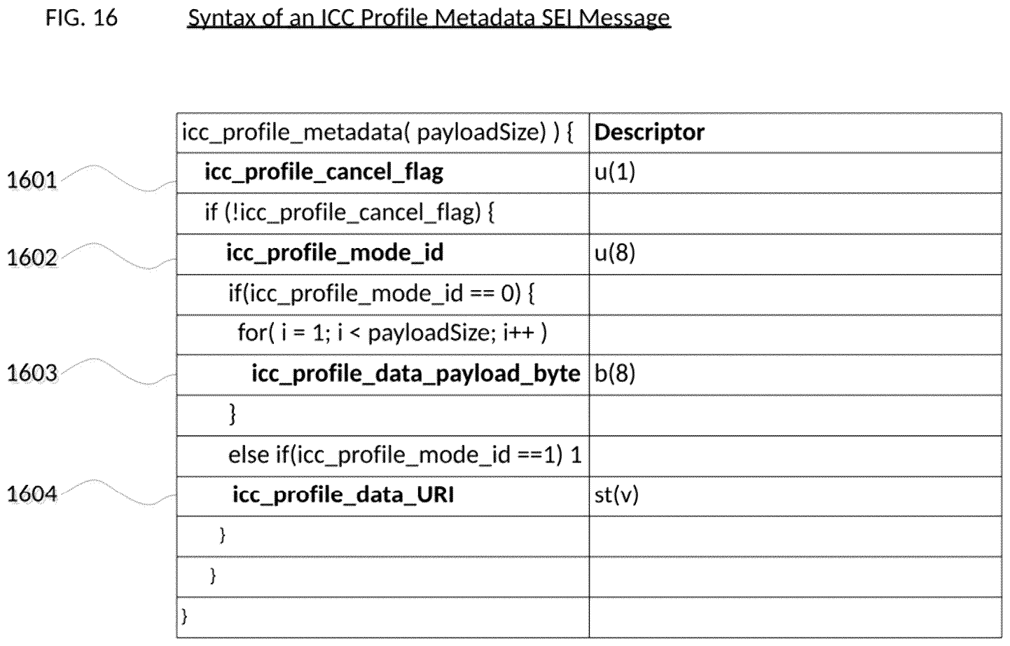

FIG. 16 can be an embodiment of a syntax for an ICC Profile SEI message. Cancel flag (1601) can be used to disable the persistence of a previously processed ICC Profile SEI message. If flag (1601) is set to a value indicating ‘false’ then ICC Profile mode ID (1602) can indicate whether the payload of the SEI message is the ICC Profile metadata itself or a URI for the location of the ICC Profile metadata. If mode ID (1602) is equal to ZERO, then ICC Profile data payload byte (1603) receives a byte of data from the SEI payload. If mode ID (1602) is equal to ONE, then ICC Profile data URI (1604) receives a string of data from the SEI payload.

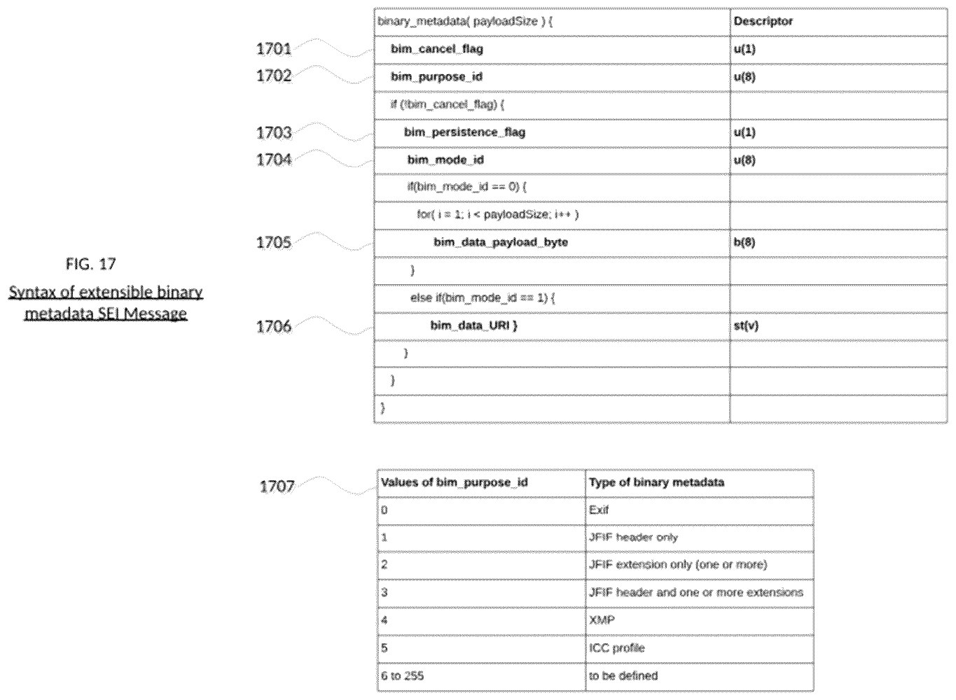

FIG. 17 is an embodiment of a syntax for a single extensible binary metadata SEI message that can carry the binary payloads of any type according to a purpose identifier. In this example, the payloads from metadata formats shown in FIG. 13, FIG. 14, FIG. 15, and FIG. 16 are illustrated. Cancel flag (1701) can be used to disable the persistence of a previously processed message with the same (1702) purpose identifier. Purpose identifier (1702) can signal the type of or purpose for the metadata payload that is carried in the remainder of the SEI payload. The interpretation of identifier (1702) can be defined in a separate table (1707). In sample table 1707 illustrated in FIG. 17, purpose identifier equal to ZERO indicates that the binary payload is EXIF metadata; purpose identifier equal to ONE indicates that the binary payload is a JFIF header (1406); purpose identifier equal to TWO indicates that the binary payload is comprised of one or more (concatenated) JFIF extension(s) (1405), purpose identifier equal to THREE indicates that the binary payload consists of a JFIF header followed immediately by one or more JFXX extensions (1404); purpose identifier equal to FOUR indicates that the binary payload consists of XMP metadata (1503); purpose identifier equal to FIVE indicates that the binary payload consists of ICC profile metadata (1603); and purpose identifiers equal to SIX or more up to and including 255 are reserved for future use. In this way, SEI syntax depicted in FIG. 17 is extensible for other binary payloads yet to be determined, e.g., for identifier values SIX through and including 255.

Referring still to FIG. 17, if flag (1701) is set to a value indicating ‘true’ then processing of the current binary metadata SEI message can complete. If flag (1701) is set to a value indicating ‘false’ then binary persistence flag (1703) signals the range by which the current binary metadata SEI message persists. As above, it can be a common practice in the specification of SEI messages that such messages define both a “cancel” and “persistence” flag, as illustrated in flags (1701) and (1703) respectively, in which case the semantics of such flags may be consistently applied throughout the VSEI standard.

Referring still to FIG. 17, if flag (1701) is set to a value of ‘false’ then Mode ID (1704) indicates the mode by which the binary metadata is carried in the SEI payload. If Mode ID (1704) is equal to a value of ZERO, then the binary metadata is carried directly in the payload of the SEI message itself, and Binary Metadata Payload Byte (1705) receives a byte of data from the SEI payload. If Mode ID (1704) is equal to ONE, then the binary metadata is stored at a location external to the video stream; said location determined by a URI carried in the payload of the SEI. In the case when Mode ID (1704) is equal to ONE, Binary URI (1706) receives a text string of data from the payload of the SEI message.

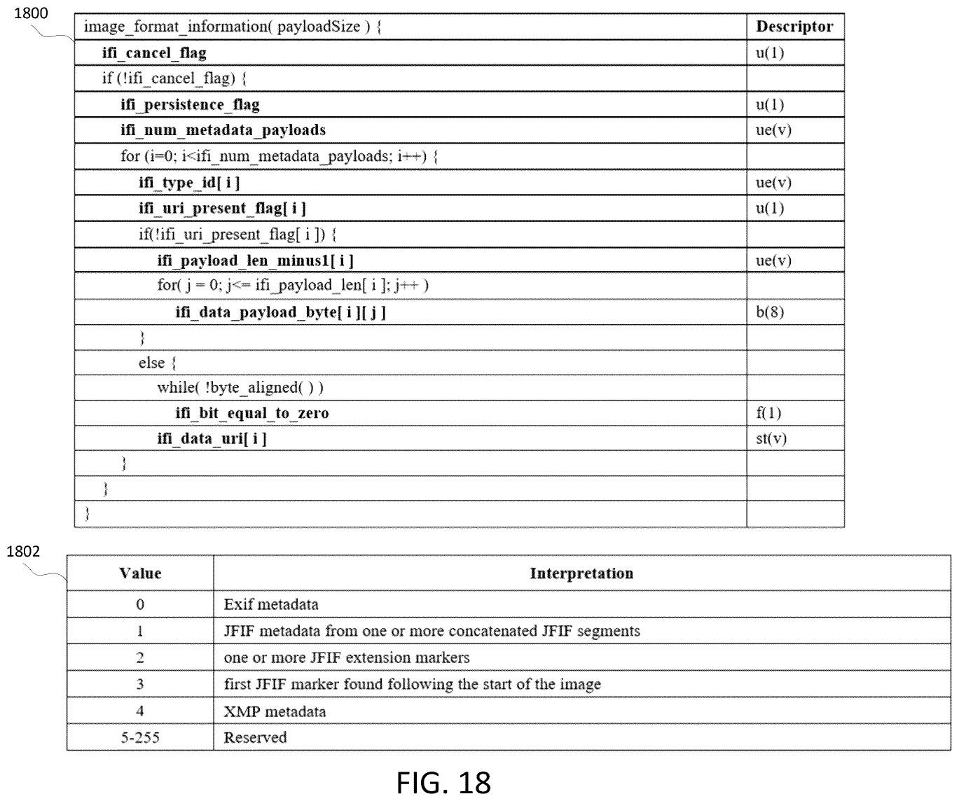

FIG. 18 is an embodiment of a syntax for a single extensible binary metadata SEI message that can carry the binary payloads of any type according to a purpose identifier.

The image format information SEI message (1800) specifies an SEI message in which the payload of EXIF, JFIF, XMP image format metadata formats can be carried in the video bitstream. The ifi_cancel_flag equal to 1 indicates that the SEI message cancels the persistence of any previous image format information SEI message in output order. ifi_cancel_flag equal to 0 indicates that image format information follows. The ifi_persistence_flag specifies the persistence of the image format information SEI message for the current layer. The ifi_persistence_flag equal to 0 specifies that the image format information SEI message applies to the current decoded picture only. The ifi_persistence_flag equal to 1 specifies that the image format information SEI message applies to the current decoded picture and persists for all subsequent pictures of the current layer in output order until one or more of the following conditions are true: (i) A new CLVS of the current layer begins; (ii) the bitstream ends; (iii) a picture in the current layer in an AU associated with an Exif metadata SEI message is output that follows the current picture in output order.

The ifi_num_metadata_payloads indicates the number of metadata payloads that follow. The ifi_bit_equal_to_zero shall be equal to zero. The ifi_type_id[i] indicates the type of the metadata payload as defined in the table (1802) illustrated in FIG. 18.

Input human interface devices may include one or more of (only one of each depicted): keyboard 1901, mouse 1902, trackpad 1903, touch screen 1910, data-glove 1904, joystick 1905, microphone 1906, scanner 1907, camera 1908.

Computer system 1900 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 1910, data-glove 1904, or joystick 1905, but there can also be tactile feedback devices that do not serve as input devices), audio output devices (such as: speakers 1909, headphones (not depicted)), visual output devices (such as screens 1910 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system 1900 can also include human accessible storage devices and their associated media such as optical media including CD/DVD ROM/RW 1920 with CD/DVD or the like media 1921, thumb-drive 1922, removable hard drive or solid-state drive 1923, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 1900 can also include interface to one or more communication networks. Networks can for example be wireless, wireline, optical. Networks can further be local, wide-area, metropolitan, vehicular, and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1949) (such as, for example USB ports of the computer system 1900; others are commonly integrated into the core of the computer system 1900 by attachment to a system bus as described below (for example Ethernet interface into a PC computer system or cellular network interface into a smartphone computer system). Using any of these networks, computer system 1900 can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 1940 of the computer system 1900.

The core 1940 can include one or more Central Processing Units (CPU) 1941, Graphics Processing Units (GPU) 1942, specialized programmable processing units in the form of Field Programmable Gate Areas (FPGA) 1943, hardware accelerators for certain tasks 1944, and so forth. These devices, along with Read-only memory (ROM) 1945, Random-access memory 1946, internal mass storage such as internal non-user accessible hard drives, SSDs, and the like 1947, may be connected through a system bus 1948. In some computer systems, the system bus 1948 can be accessible in the form of one or more physical plugs to enable extensions by additional CPUs, GPU, and the like. The peripheral devices can be attached either directly to the core's system bus 1948, or through a peripheral bus 1949. Architectures for a peripheral bus include PCI, USB, and the like.

CPUs 1941, GPUs 1942, FPGAs 1943, and accelerators 1944 can execute certain instructions that, in combination, can make up the aforementioned computer code. That computer code can be stored in ROM 1945 or RAM 1946. Transitional data can be also be stored in RAM 1946, whereas permanent data can be stored for example, in the internal mass storage 1947. Fast storage and retrieve to any of the memory devices can be enabled through the use of cache memory, that can be closely associated with one or more CPU 1941, GPU 1942, mass storage 1947, ROM 1945, RAM 1946, and the like.

The computer readable media can have computer code thereon for performing various computer-implemented operations. The media and computer code can be those specially designed and constructed for the purposes of the present disclosure, or they can be of the kind well known and available to those having skill in the computer software arts. As an example and not by way of limitation, the computer system having architecture 1900, and specifically the core 1940 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 1940 that are of non-transitory nature, such as core-internal mass storage 1947 or ROM 1945. The software implementing various embodiments of the present disclosure can be stored in such devices and executed by core 1940. A computer-readable medium can include one or more memory devices or chips, according to particular needs. The software can cause the core 1940 and specifically the processors therein (including CPU, GPU, FPGA, and the like) to execute particular processes or particular parts of particular processes described herein, including defining data structures stored in RAM 1946 and modifying such data structures according to the processes defined by the software. In addition or as an alternative, the computer system can provide functionality as a result of logic hardwired or otherwise embodied in a circuit (for example: accelerator 1944), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:
(1) A method performed by at least one processor in a decoder includes receiving a bitstream comprising visual media data, a supplementary enhancement information (SEI) message, and a first identifier included in a payload of the SEI message; extracting, from the SEI message in accordance with the first identifier, metadata or information referencing the metadata; and decoding the visual media data in accordance with the metadata, in which the metadata comprises binary data, in which referencing the metadata by the SEI message is performed through use of a Uniform Resource Identifier (URI) in the payload of the SEI message, in which interpretation of the first identifier is defined externally to the payload of the SEI message.
(2) The method according to feature (1), the method further including: determining a value of the first identifier; in response to determining the value of the first identifier is a first value, extracting the metadata from the payload of the SEI message; and in response to determining the value of the first identifier is a second value, referencing the metadata through use of the URI included in the payload of the SEI message.
(3) The method according to feature (1) or (2) further including, in which the bitstream further includes a payload size, and in which in response to determining the value of the first identifier is the first value, an amount of the metadata extracted from the payload of the SEI message is in accordance with the payload size.
(4) The method according to any one of features (1)-(3), further including in which the bitstream includes a second identifier that indicates a type of the binary metadata.
(5) The method according to feature (4), further including, in which the second identifier has a first value that indicates the type of the binary metadata is Exchangeable Image File (Exif), a second value that indicates the type of the binary metadata is JFXX, and a third value that indicates the type of the binary metadata is Extreme Memory Profile (XMP).
(6) The method according to feature (5), in which the second identifier has a fourth value that indicates the type of the binary metadata is a JPEG File Interchange Format (JFIF) header only, a fifth value that indicates the type of the binary metadata is a JFIF extension only, and a sixth value that indicates the type of the binary metadata is both the JFIF header and the JFIF extension.
(7) The method according to any one of features (1)-(6), in which the bitstream further comprises a cancel flag, and in which the first identifier is extracted in accordance with a value of the cancel flag.
(8) The method according to any one of features (1)-(7), in which the SEI message is an International Color Consortium (ICC) profile SEI message.
(9) The method performed by at least one processor in an encoder, the method includes: receiving visual media data; generating a supplemental enhancement information (SEI) message in which a payload of the SEI message includes a first identifier and metadata or a reference to the metadata, encoding the visual media data in accordance with the metadata, generating a bitstream comprising the visual media data and the SEI message, in which the metadata comprises binary data, in which the first identifier indicates whether the payload of the SEI message includes the metadata or a reference to the metadata, in which referencing the metadata by the SEI message is performed through use of a Uniform Resource Identifier (URI) in the payload of the SEI message, and in which interpretation of the first identifier is defined externally to the payload of the SEI message.
(10) The method according to feature (9), the method further including: in which the first identifier has a first value that indicates the metadata is included in the payload of the SEI message, and in which the first identifier has a second value that indicates the payload includes the URI that references the metadata.
(11) The method according to feature (9) or (10), in which the bitstream further includes a payload size, and in which in response to the first identifier having the first value, an amount of the metadata extracted from the payload of the SEI message is in accordance with the payload size.
(12) The method according to feature (9)-(11), in which the bitstream includes a second identifier that indicates a type of the binary metadata.
(13) The method according to feature (12), in which the second identifier has a first value that indicates the type of the binary metadata is Exchangeable Image File (Exif), a second value that indicates the type of the binary metadata is JFXX, and a third value that indicates the type of the binary metadata is Extreme Memory Profile (XMP).
(14) The method according to feature (13), in which the second identifier has a fourth value that indicates the type of the binary metadata is a JPEG File Interchange Format (JFIF) header only, a fifth value that indicates the type of the binary metadata is a JFIF extension only, and a sixth value that indicates the type of the binary metadata is both the JFIF header and the JFIF extension.
(15) The method according to any one of features (9)-(14), in which the bitstream further comprises a cancel flag, and in which the first identifier is extracted in accordance with a value of the cancel flag.
(16) The method according to any one of features (9)-(15), in which the SEI message is an International Color Consortium (ICC) profile SEI message.
(17) A method of processing visual media data, the method including: processing a bitstream of visual media data according to a format rule, in which the bitstream includes a supplemental enhancement information (SEI) message in which a payload of the SEI message includes a first identifier and metadata or a reference to the metadata, in which the metadata comprises binary data, in which the first identifier indicates whether the payload of the SEI message includes the metadata or a reference to the metadata, in which referencing the metadata by the SEI message is performed through use of a Uniform Resource Identifier (URI) in the payload of the SEI message, and in which interpretation of the first identifier is defined externally to the payload of the SEI message.
(18) The method according to feature (17), the method further including: in which the first identifier has a first value that indicates the metadata is included in the payload of the SEI message, and in which the first identifier has a second value that indicates the payload includes the URI that references the metadata.
(19) The method according to feature (18), in which the bitstream further includes a payload size, and in which in response to the first identifier having the first value, an amount of the metadata extracted from the payload of the SEI message is in accordance with the payload size.
(20) The method according to feature (19), in which the bitstream includes a second identifier that indicates a type of the binary metadata.

1. A method performed by at least one processor in a decoder, the method comprising:
receiving a bitstream comprising visual media data, a supplementary enhancement information (SEI) message, and a first identifier included in a payload of the SEI message;
extracting, from the SEI message in accordance with the first identifier, metadata or information referencing the metadata; and
decoding the visual media data in accordance with the metadata,
wherein the metadata comprises binary data,
wherein referencing the metadata by the SEI message is performed through use of a Uniform Resource Identifier (URI) in the payload of the SEI message,
wherein interpretation of the first identifier is defined externally to the payload of the SEI message.

2. The method according to claim 1, the method further comprising:
determining a value of the first identifier;
in response to determining the value of the first identifier is a first value, extracting the metadata from the payload of the SEI message; and
in response to determining the value of the first identifier is a second value, referencing the metadata through use of the URI included in the payload of the SEI message.

3. The method according to claim 1, wherein the bitstream further includes a payload size, and wherein in response to determining the value of the first identifier is the first value, an amount of the metadata extracted from the payload of the SEI message is in accordance with the payload size.

4. The method according to claim 1, wherein the bitstream includes a second identifier that indicates a type of the binary metadata.

5. The method according to claim 4, wherein the second identifier has a first value that indicates the type of the binary metadata is Exchangeable Image File (Exif), a second value that indicates the type of the binary metadata is JFXX, and a third value that indicates the type of the binary metadata is Extreme Memory Profile (XMP).

6. The method according to claim 5, wherein the second identifier has a fourth value that indicates the type of the binary metadata is a JPEG File Interchange Format (JFIF) header only, a fifth value that indicates the type of the binary metadata is a JFIF extension only, and a sixth value that indicates the type of the binary metadata is both the JFIF header and the JFIF extension.

7. The method according to claim 1, wherein the bitstream further comprises a cancel flag, and wherein the first identifier is extracted in accordance with a value of the cancel flag.

8. The method according to claim 1, wherein the SEI message is an International Color

9. A method performed by at least one processor in an encoder, the method comprising:
receiving visual media data;
generating a supplemental enhancement information (SEI) message in which a payload of the SEI message includes a first identifier and metadata or a reference to the metadata,
encoding the visual media data in accordance with the metadata,
generating a bitstream comprising the visual media data and the SEI message,
wherein the metadata comprises binary data,
wherein the first identifier indicates whether the payload of the SEI message includes the metadata or a reference to the metadata,
wherein referencing the metadata by the SEI message is performed through use of a Uniform Resource Identifier (URI) in the payload of the SEI message, and
wherein interpretation of the first identifier is defined externally to the payload of the SEI message.

10. The method according to claim 9, the method further comprising:
wherein the first identifier has a first value that indicates the metadata is included in the payload of the SEI message, and
wherein the first identifier has a second value that indicates the payload includes the URI that references the metadata.

11. The method according to claim 9, wherein the bitstream further includes a payload size, and wherein in response to the first identifier having the first value, an amount of the metadata extracted from the payload of the SEI message is in accordance with the payload size.

12. The method according to claim 9, wherein the bitstream includes a second identifier that indicates a type of the binary metadata.

13. The method according to claim 12, wherein the second identifier has a first value that indicates the type of the binary metadata is Exchangeable Image File (Exif), a second value that indicates the type of the binary metadata is JFXX, and a third value that indicates the type of the binary metadata is Extreme Memory Profile (XMP).

14. The method according to claim 13, wherein the second identifier has a fourth value that indicates the type of the binary metadata is a JPEG File Interchange Format (JFIF) header only, a fifth value that indicates the type of the binary metadata is a JFIF extension only, and a sixth value that indicates the type of the binary metadata is both the JFIF header and the JFIF extension.

15. The method according to claim 9, wherein the bitstream further comprises a cancel flag, and wherein the first identifier is extracted in accordance with a value of the cancel flag.

16. The method according to claim 9, wherein the SEI message is an International Color Consortium (ICC) profile SEI message.

17. A method of processing visual media data, the method comprising:
processing a bitstream of visual media data according to a format rule,
wherein the bitstream includes a supplemental enhancement information (SEI) message in which a payload of the SEI message includes a first identifier and metadata or a reference to the metadata,
wherein the metadata comprises binary data,
wherein the first identifier indicates whether the payload of the SEI message includes the metadata or a reference to the metadata,
wherein referencing the metadata by the SEI message is performed through use of a Uniform Resource Identifier (URI) in the payload of the SEI message, and
wherein interpretation of the first identifier is defined externally to the payload of the SEI message.

18. The method according to claim 17, the method further comprising:
wherein the first identifier has a first value that indicates the metadata is included in the payload of the SEI message, and
wherein the first identifier has a second value that indicates the payload includes the URI that references the metadata.

19. The method according to claim 18, wherein the bitstream further includes a payload size, and wherein in response to the first identifier having the first value, an amount of the metadata extracted from the payload of the SEI message is in accordance with the payload size.

20. The method according to claim 19. wherein the bitstream includes a second identifier that indicates a type of the binary metadata.
